(19) United States
(12) Patent Application Publication
(10) Pub. No.: US 2026/0243631 A1
(43) Pub. Date: Aug. 20, 2026

(54) Devices and Methods for High-Volume Sampling, Extraction, and Purification of Biological and Chemical Targets

(71) Applicant: PureBioX, Inc., Saint Paul, MN (US)

(72) Inventor: Abdennour Abbas, Falcon Heights, MN (US)

(73) Assignee: PureBioX, Inc., Saint Paul, MN (US)

(21) Appl. No.: 19/162,813

(22) PCT Filed: Apr. 1, 2024
(86) PCT No.: PCT/US2024/022517

§ 371 Date: Sep. 5, 2025

Related U.S. Application Data
(60) Provisional application No. 63/455,761, filed on Mar. 30, 2023.
(60) Provisional application No. 63/506,461, filed on Jun. 6, 2023.

(51) Int. Cl. G01N 1/22; G01N 1/10

(52) U.S. Cl. CPC G01N 1/2205; G01N 1/10; G01N 2001/1043

(57) ABSTRACT

Embodiments of the present disclosure include improved water filtration systems and devices that increase efficiency and reduce cost. Embodiments include water filters within a filter cartridge where the filter cartridge includes one or more fittings and where the filter cartridge is securable directly to a centrifuge tube without needing to remove the filter that has trapped the target of interest taken from a sample from the filter cartridge. The system and devices include filter cartridges for taking a sample from air, water, and/or a surface.

### CROSS REFERENCE TO RELATED APPLICATIONS

The present application claims priority to U.S. Provisional Application Ser. No. 63/455,761 filed Mar. 30, 2023 and entitled “Devices and Methods for High-Volume Sampling, Extraction, and Purification of Biological and Chemical Targets” and U.S. Provisional Application Ser. No. 63/506,461 filed Jun. 6, 2023 and entitled “Devices and Methods for High-Volume Sampling, Extraction, and Purification of Biological and Chemical Targets”, the contents of which are hereby incorporated into the present application in their entirety.

### BACKGROUND

Several applications in the industry require the filtration of large volumes of fluids (air or liquid). For example, wastewater epidemiology requires around 300 mL for each sample. Bio conservation and ecosystem monitoring using environmental DNA (eDNA) requires from 300 mL to several liters for each sample due to low concentrations of eDNA in the environment. Other examples include pathogen and invasive species detection in the air using airborne DNA, DNA forensics, pharmaceutical applications in which large scale filtration of therapeutics is needed to reduce costs, and microbial monitoring in spacecraft environments.

High-volume sampling is particularly important for all applications related to waterborne or airborne eDNA. Whether it is microorganisms, spores, cells, tissues or free nucleic acids, this is all part of what is known for conservation biologists as Environmental DNA and RNA (eDNA/eRNA), used for the detection of native, invasive or rare species in environmental water.

eDNA has seen a growing interest from the research community over the last few years for a variety of biomonitoring applications. It has been used to detect ancient DNA, aquatic invasive species and rare species or survey diversity in aquatic environments, and more recently for monitoring plants, vertebrates and invertebrates in land and the detection of allergens and pathogens. Studies including these uses show the promise of eDNA to provide less time-intensive approaches, improve taxonomic recovery (detecting species not detected with traditional methods) and be less invasive. The studies also highlight the need for improved sampling methods. While the detection of eDNA can be efficiently conducted using powerful techniques such as qPCR, LAMP assays and genome sequencing or metabarcoding, a major limitation that prevents the widespread and routine use of eDNA is the lack of dedicated and standardized sampling tools that are efficient, user-friendly, and compatible with downstream sample processing.

Currently, there is no agreement, nor are their standards in the industry or in academia on the volume of water or air samples needed for reliable detection of species in air or water. The same is true for how much sample is needed to detect species on surfaces. For example, the sample volume currently collected for each test in wastewater epidemiology ranges from 10 mL to 300 mL. There is no scientific study assessing the minimal and optimal sample volume of wastewater for pathogen detection.

A number of studies on eDNA revealed the necessity of collecting large volumes of water (1-10 L) to increase the probability of species detection. The widely adopted protocols for eDNA sample collection produced by the U.S. Geological Survey and the National Genomics Center for Wildlife and Fish Conservation (1-10 L sample volume) effectively collect up to 500 times more DNA than protocols that sample less than 100 mL of water as it is practiced in wastewater epidemiology today. Demonstrating and enabling a practical use of water samples with large volumes would be a game-changer in many industry and academic applications today, both in terms of cost and performance.

Currently, environmental samples (from water, air and surfaces) are collected by using filtration systems. These systems either cannot process large volumes or they use in-house built systems that use a pump to draw air or water through a regular purification filter. The filter is subsequently cut into small pieces to perform extraction of the target chemical or biological material, which is labor-intensive and time-consuming. Other techniques rely on passive sampling by using dust traps and gravitation-based or electrostatic traps which need long collection times. Other systems use liquid cyclone samplers, but these have lower collection efficiency for particles with diameter smaller than 0.5 μm and can suffer from limited sampling time, resulting in limited sampling volume and lower statistical power. Liquid cyclone samples also have the potential to cause over-or under-sampling issues and capture less than 10% of particulates smaller than 0.5 micrometer.

As such, while eDNA offers tremendous possibilities, the design of current systems limits its practical application. Thus, what is needed is a filtration system for use with sampling air, water, and/or surfaces that maximizes the capture of biological systems in order to minimize the risk of contamination and to increase efficiency and reduce cost.

### BRIEF SUMMARY

The present disclosure in some embodiments includes a filter cartridge for collecting samples for testing. The filter cartridge includes a filter that has a top end and a bottom end. The filter also includes multiple layers of corrugated filter material. A hollow core runs through the center of the filter from the top end of the filter to the bottom end of the filter. The filter cartridge also includes a housing. The housing includes a top support connected to the top end of the filter and the top support covers the entire top end of the filter. The top support also includes a flange that extends down toward the bottom end of the filter. The flange is spaced apart from the filter to create a gap between the flange and the filter. The top support also includes an opening to access the filter. The opening is surrounded by a fitting. The bottom support has a circumference that is smaller than the circumference of the top support. The bottom support also has a center cylinder that is centrally placed on and connected to a top surface of the bottom support. The circumference of the center cylinder is smaller than the circumference of the bottom support. When the bottom support is connected to the filter, the center cylinder of the bottom support resides in the hollow core of the filter and the bottom end of the filter connects to the top surface of the bottom support.

In some embodiments, the filter cartridge is used to collect samples from the air.

In some embodiments, the filter cartridge for collecting air samples further includes an adapter that connects the filter cartridge to a handheld vacuum for collecting a sample from the air.

In some embodiments, the filter material comprises a HEPA material.

In some embodiments, the center cylinder is non-hollow.

In some embodiments, the filter cartridge also includes a removably securable cap that secures to the fitting on the top support.

In some embodiments, an interior side of the flange closest to the filter includes a plurality of projections.

In some embodiments, the top support of the filter cartridge secures to a centrifuge tube. In some embodiments, the top support of the filter cartridge secures to, or also secures to a spin tube.

In another embodiment, a filter cartridge for collecting sample from water includes a filter with a top end and a bottom end. The filter has a hollow core running from the top end to the bottom end. The filter cartridge also includes a housing body that the entire filter fits inside of. The housing body includes a top support that fits over a top end of the housing body, and a bottom support that covers the bottom end of the housing body. The top support has an opening to access the filter that is placed in the housing.

The opening in the top support is surrounded by a fitting. The bottom support has an opening to access the filter that is in the housing. The opening in the bottom support is surrounded by a fitting. There is also a central cylinder that runs from the top support to the bottom support through the hollow core of the filter.

In some embodiments, the filter cartridge may also include a removably securable cap that secures to the fitting of the top support. In some embodiments, the filter cartridge may also have a removably securable cap that secures to the bottom support.

In some embodiments, the top support may removably secure to a centrifuge tube. In some embodiments, the top support may or may also removably secure to a spin tube.

In some embodiments, the filter is made of two or more filter material layers, where the material of each filter material layer has a pore size.

In some embodiments, at least two of the more than two filter material layers have filter material with different pore sizes.

In another embodiment, a method of processing environmental samples is disclosed. The method includes placing a filter cartridge for collecting the environmental sample in a location of interest. The filter cartridge has a filter disposed between a top support and a bottom support. The top support has an opening to access the filter disposed therein and the opening is surrounded by a fitting. Then the filter cartridge is placed into a centrifuge tube, after the environmental sample has been collected. The top support of the filter cartridge secures to a top of the centrifuge tube without needing to remove the filter from the filter cartridge. Next, a centrifuging fluid is poured through the opening of the top support. Centrifuge is performed on the centrifuge tube containing the filter cartridge containing the environmental sample. After centrifuge, the sample is collected and placed in a spin tube with a washing buffer solution and centrifuged. After centrifuge, the sample is collected and placed in a collection tube along with a buffer solution and centrifuged to produce a concentrated target that can then be analyzed.

In some embodiments, the location of interest is a surface.

In some embodiments, the location of interest is water.

### BRIEF DESCRIPTION OF THE DRAWINGS

The following drawings are illustrative of embodiments and do not limit the scope of the invention. The drawings are not necessarily to scale and are intended for use in conjunction with the following detailed description. Embodiments of the invention will be described with reference to the drawings, in which like numerals may represent like elements.

FIG. 1 is a side view of a high-volume sampling device for airborne, and surface-borne targets.

FIG. 2 is a partial cutaway side view of a filtration cartridge connected to a fitting for use with either airborne or waterborne targets;

FIG. 3 is a partial cutaway side view of the filtration cartridge of FIG. 2 with a disconnected cap;

FIG. 4 is a sectional end view at C-C of the filtration cartridge of FIG. 2;

FIG. 5 is an exploded side view of the filtration cartridge of FIG. 2 and a cap;

FIG. 6 is a partial cutaway side view of an alternative embodiment of a filtration cartridge for use with airborne or waterborne targets according to various embodiments, connected to a fitting;

FIG. 7 is a partial cutaway view of the filtration cartridge of FIG. 6 with a disconnected cap;

FIG. 8 is a representative diagram of a method of using a filtration cartridge according to various embodiments;

FIG. 9 is a partial cutaway side view of a water filtration cartridge according to various embodiments;

FIG. 10 is a sectional end view at C-C of the water filtration cartridge of FIG. 9;

FIG. 11 is a partial cutaway side view of a top portion of the water filtration cartridge of FIG. 9;

FIG. 12 is an exploded side view of a bottom portion of the water filtration cartridge of FIG. 9;

FIG. 13 is a representative diagram of a method of using a water filtration cartridge according to various embodiments; and

FIG. 14 is a representative side view of a layered filter according to various embodiments.

FIG. 15 is an exploded view of a filtration device for water according to some embodiments of the present disclosure.

FIG. 16 is an assembled view of the water filtration device of FIG. 15.

FIG. 17 is an exploded view of another embodiment of a water filtration device, according to some embodiments of the present disclosure.

FIG. 18 is an assembled view of the water filtration device of FIG. 17.

### DETAILED DESCRIPTION

The following detailed description is exemplary in nature and is not intended to limit the scope, applicability, or configuration of the invention. Rather, the following description provides practical illustrations for implementing various exemplary embodiments. Utilizing the teachings provided herein, those skilled in the art may recognize that many of the examples have suitable alternatives.

Various embodiments include systems and methods to collect biological and/or chemical materials from high volumes of air, water or large surfaces, such as environmental sources. The biological or chemical materials may be present in very low quantities and captured by filtration systems. These filtration systems may be configured to maximize the capture of the biological systems, to minimize the risk of contamination, to increase efficiency, and to reduce costs.

In some embodiments, the devices and methods are designed to easily and efficiently connect with downstream processing tools of the collected samples, such as systems for extraction and purification of the collected material.

Materials which may be captured using the filtration systems and methods include, but are not limited to biological, chemical, and other materials which may be present in very low quantities. Examples of biological materials which may be captured include, but are not limited to nucleic acids such as DNA and RNA, such as those from currently living or extinct species in nature such as for bioconservation monitoring, from bacteria or viruses such as for pathogen monitoring. For example, the systems may be used for pathogen monitoring in water systems such as public drinking water or in sewage systems. These could include, for example, pathogens which periodically cause outbreaks such as influenza, cholera, polio, COVID-19, measles, and legionella.In other examples, the systems may be used for pathogen monitoring on surfaces where the existence of pathogens are of particular concern such as food production facilities for food safety (such as for E. coli, listeria, campylobacter, salmonella, and norovirus) or health care facilities (such as streptococcus including methicillin-resistant Staphylococcus aureus, pseudomonas, clostridium difficile, and COVID), elder care facilities, spacecraft, and other environments. Examples of chemicals which may be captured from the water or air include environmental contaminants such as lead and PFAS, for example. For example, the systems may be used for monitoring or periodic analysis of public drinking water systems or private drinking water sources such as wells. As such, the high-volume collection and purification systems and methods may be useful for bio conservation monitoring, wastewater-based epidemiology, biodefense, food safety, forensics, pharmaceuticals, biocontrol in spacecrafts, and other molecular and microbiological diagnostics needs.

The high-volume throughput systems of various embodiments may be used to collect material from sources including water, air, and surfaces, for example. Water sources may include public water systems including water treatment facilities and water storage reservoirs such as tanks, wells, natural water bodies such as lakes, rivers, ponds, and oceans, and sewage systems such as sewage treatment plants and septic systems. Air born collection sources may include any indoor or outdoor location but may be particularly useful in locations where pathogen control is most important (health care facilities and especially operating rooms or infection control areas, food processing or production facilities, research laboratories, and medical equipment manufacturing), locations at greater risk of environmental contamination (areas surrounding manufacturing plants such as chemical plants and densely populated areas) or areas of special research interest such as new and emerging diseases.

Various embodiments include filters and filtrations systems which may be used to collect biological, chemical or other small quantity materials from high throughput systems. The process results in a concentrated small volume of collected material, such as nucleic acid that can be easily and rapidly identified using techniques such as polymerase chain reaction, genetic sequencing, mass spectrometry or other chemical and bioanalytical methods.

The filter and filter cartridges used in various embodiments include various improvements to improve the efficiency of sample collection, reduce sample contamination, and reduce cost. For example, certain embodiments include a filtration cartridge with a specific flange size and design that includes one or more innovative features. In some embodiments, the design of the filter results in an increased filter surface area. For example, the filter may be a pleated or a corrugated filter forming a conical or cylindrical shape. This configuration may increase the surface area at least 100 times as compared to one-dimensional filters. In addition to increased surface area that increases capture efficiency, the high surface to volume ration enables larger flow rates and higher loading capacity.

In some embodiments, the filter may include a layered design. For example, the filter may include multiple layers of corrugated or pleated filters, such as, but not limited to between 1 or 2 and about 10 filters. This design further increases the surface area. It also allows for more contact between the water or the air and the filter, which increases the filter's loading capacity.

In some embodiments, the filter may be a column filter. In some embodiments, the column filter may be comprised of plastic and have a flat filter disc at the bottom of the column. The flat filter disc may be similar to the corrugated filter described herein, including having multiple layers, though in the column filter design, the filter is flat. The column may then be filled with water to be sampled. The water passes through the filter using a vacuum system or centrifugation.

Some filters may also include nanoscale materials such as nanofibers and nanostructures. The inclusion of nanoscale materials in the filters may further increase the surface-to-volume ratio and increase the number of binding sites in the filters.

In some embodiments, the filters may include hollow fibers. For example, the hollow fibers may be packed or arranged to have their longitudinal direction parallel to the flow of the media to be filtered. The hollow fibers may have a diameter ranging from about 100 nanometer to about 5 millimeters, for example. The hollow fibers may replace or supplement the filter used. The hollow fibers allow filtration of very small components of interest, such as proteins.

In some embodiments, the filter(s) may be shaped in a spiral wound design, which may allow more filter to be included in the filter space, further increasing the surface area of the filter that is exposed, and through which the media must pass. In a spiral wound design, the filter material may be wound around a central core in a spiral pattern. The filter may include multiple layers, including alternating layers of permeable membrane filters and impermeable spacer layers with channels. The channels of the spacer layers between the layers of permeable membrane allow water to flow through the filter while also increasing the surface area available for filtration. The spacers may also enhance mixing and turbulence inside the cartridge.

The spiral wound design may be achieved in several ways. In some embodiments, a sheet of filter material may be wound around a central core, creating a series of concentric layers. This wound filter may then be inserted into a cartridge in spiral form, with or without the central core. In some embodiments, a pre-formed filter element that is already spirally wound may be used. This pre-wound filter may be inserted into the cartridge. By incorporating a spiral wound design, the surface area of the filter may be increased by up to two or three times, depending, for example, on the number of layers of membrane and spacers used. This design can significantly increase the filter's loading capacity to capture material such as nucleic acid, microorganisms, and other materials without increasing the size of the cartridge.

In addition to improved filter designs, various embodiments may also include improvements to the cartridge design. For example, the filtration cartridge (collection device) dimensions and features may be designed specifically to securely fit into and interconnect with extraction and purification tools. For example, a 50 mL centrifuge tube is a typical element of an extraction and purification system, and various embodiments of the filter cartridge may be designed to fit within and interconnect with the 50 mL centrifuge tube without modification. For example, various embodiments may include a flange with a reduced diameter, such as a diameter large enough for high-volume samples but sized to fit into a standard sized centrifuge tube. For example, the flange diameter may be between about 10 mm and about 60 mm, or between 20 mm and about 40 mm, or between about 25 and about 35 mm.

In various embodiments, the corrugated filter cartridge may be configured and sized at each end to fit tightly into centrifuge tubes at one end and air filtration or water pumping devices in the other end. The direct fit of the filtration cartridge into a centrifuge or extraction tube as provided in various embodiments enables easy and straightforward downstream processing of the sample without touching or cutting the filters, thus preventing cross-contaminations, and reducing processing time.

In various embodiments, the filter material may be a plastic and/or an organic material such as cellulose to build the corrugated filters. The filter may include only organic material or a combination of organic and synthetic material such as plastics. In some embodiments, the filter cartridge may include multiple filters, such between about one or two and about ten. In some such embodiments, the filters may all have pores of the same size. Alternatively, the filters may not all have pores of the same size. For example, the pore sizes may vary from filter to filter, such as between about 0.1 micrometers and about 10 micrometers. Each filter may have a different pore size than all of the other filters. Groups of filters, such as two or three filters, may have the same pore size with different groups having different pore sizes. The use of multiple filters, with different pore sizes in some or all of the filters, may enable the capture of different materials and reduce clogging issues.

While the embodiments described above use or combine the multiple features, embodiments may be constructed that use one or more of the features described above.

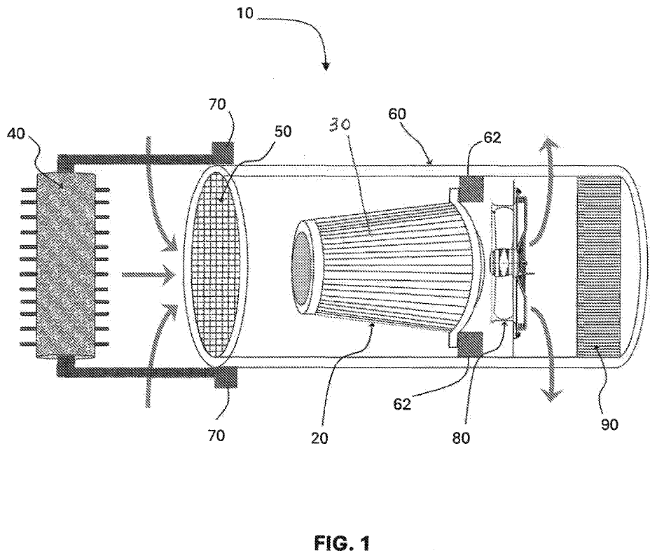

The filter may be a component of a filter cartridge, as described above. An example of a filtration system according to various embodiments is shown in FIG. 1.

FIG. 1 shows an example of an air or surface filtration device 10, with the direction of air flow indicated by the arrows. The air filtration device 10 of FIG. 1 may be used for high-volume sampling of airborne and surface-borne targets, for example.

The device 10 includes a filter cartridge 20 for the capture and extraction of targets such as biological and chemical targets. The air flow passes through the filter cartridge 20 while target entities are blocked by and are bound to the corrugated porous filters 30 within the cartridge 20. The corrugated filter 30 may include multiple filter layers and may also include spacers and/or different pore sizes, as described above. The embodiment shown further includes an optional brush 40, such as a rotating or non-rotating brush, which may be used for the collection of surface biomass such as by contacting the brush with a surface and sweeping the surface for collection. This embodiment further includes an optional mesh 50 which may be used for blocking large particles to prevent filter clogging. The device 10 includes a housing 60 which may be a rigid housing surrounding the filter cartridge 20, with all air passing through the mesh 50 prior to the filter 30. The housing may include one or more connectors, such as connector 62 which projects inward from the inside surface of the housing to hold the downstream end of the filtration cartridge 20 and block airflow around the filtration cartridge 20. The brush 40 may be located upstream of the mesh 50 and may include attachment elements 70 such as a clamp or ribs to attach and detach the brush from the housing 60 as desired depending upon use. The device 10 may further include a fan 80 to assist in drawing air through the filter 30 and assist in expelling the air out through one or more outlet ventilation holes at the downstream and of the housing 60. The system 10 may further include a power source such as a battery 90 or may be externally powered such as by connection to an outlet through a cord.

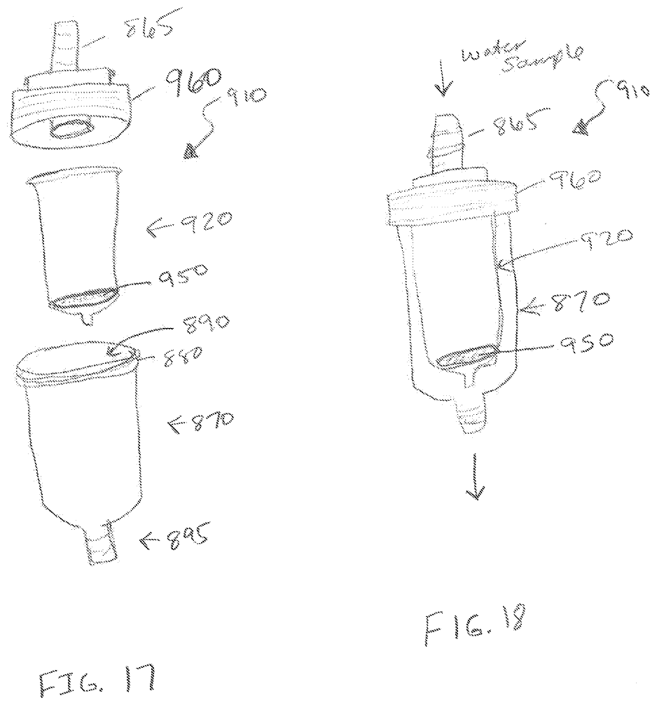

FIGS. 15 and 16 show a water filtration device 810, where in FIG. 15 the parts of the water filtration device 810 are shown in exploded view, and in FIG. 16 the parts of the water filtration device 810 are shown in an assembled view. As may be seen, water filtration device 810 may include filter cartridge 820, which may include a top support 830 and bottom support 840, along with filter 850 that may be comprised of filter material as described herein in various embodiments, including having multiple layers of filter material. Device 810 also includes a housing 870. Housing 870 includes a filter cartridge receiving end 890 that has means for coupling 880 to top support 830 of filter cartridge 820. Means for coupling top support to filter cartridge receiving end of housing can include screw fit connection, snap fit connection, friction fit connection, and any other method of securing top support 830 to filter cartridge receiving end 890 of housing 870. Housing 870 also has a water intake end 895 that allows water to be pumped into and through the housing. In addition, water filtration device 810 includes a cap 860 that has an adapter 865 attached thereto, such that the adapter may connect to a water hose, for example. As explained with regard to other embodiments, top support 830 may include an opening with a fitting that may secure to the cap 860 with the adapter 865. In some embodiments, as is described herein with regard to other embodiments, the filter may have a hollow core running through its center from the top support to the bottom support. A center cylinder may be placed in the hollow core of the filter in order to minimize the amount of reagent needed for processing. As may be seen in FIG. 16, water is pumped from the water intake end 895 of housing 870 to and through the adapter 865 at the other end of the water filtration device 810.

FIGS. 17 and 18 show a water filtration device 910, where in FIG. 17 the parts of the water filtration device 910 are shown in exploded view, and in FIG. 18, the parts of the water filtration device 910 are shown in an assembled view. The housing 870 may be the same or substantially the same as that described with regard to the embodiment shown in FIGS. 15 and 16. However, instead of the corrugated filter cartridge shown in FIGS. 15 and 16, the embodiment shown in FIGS. 17 and 18 include a column filter cartridge 920. The filter 950 may be a disc shaped filter fit into the bottom of the cartridge 920. The filter 950 may be comprised of the same material as disclosed herein for other embodiments descried. The device 910 may also include a cap 960 with an adapter 865, where the adapter 865 may connect to a water tube for example. The cap 960 may be configured to couple with filter cartridge receiving end 890 of the housing 870 in the same way as is described above in relation to the top support being configured to couple with the filter cartridge receiving end 890 of the housing 870. As shown in FIG. 18, in this embodiment, water flows from the adapter into and through the water intake end 895.

In use, a user may insert a new filtration cartridge into the device 10 (though it is to be understood that the device may be any device embodiment disclosed herein, including, but not limited to device 810 or 910, for example) and may power the device on to allow large volumes of air to pass through the filtration cartridge. For sample collection from surfaces, the rotating or non-rotating brush 40 may be connected to the upstream end of the air circulating device 10. The brush 40 may be used to sweep surfaces and detach any bound target, such as biological or chemical materials, which may subsequently be collected with the air circulating device 10 and passed through the filtration cartridge 20.

After use in filtration for the necessary amount of time to collect target material in the filtration cartridge, the filtration cartridge may be removed and inserted into another receptacle for collection of the target, such as a centrifuge tube like a 50 mL centrifuge tube. This may be done by simply removing the filter cartridge 20 from the device 10 such as by detaching it and/or sliding it out of the device 10, and sliding it onto and/or attaching it to the receptacle, without any further manipulation or modification of the filter, without touching the filter 30 with any hands or instruments, and without modifying the size or shape of the filter 30.

Next, in some embodiments, the target may be removed from the filter by adding a liquid to the centrifuge tube, such as a lysis buffer. In some embodiments, a user may add about 10 to about 20 mL of lysis buffer to the centrifuge tube. The receptacle such as the centrifuge tube may then be closed, such as by capping the tube.

The receptacle may then be inserted into a device to extract the target from the filter. For example, the receptacle, such as the centrifuge tube may be inserted into a centrifuge or a pumping system to release the lysis buffer containing the biological and chemical materials into to the centrifuge tube.

The solution may then be moved into a spin column to which a wash buffer may be added. The spin column may then be centrifuged to remove the wash solution.

The spin column containing the biological and chemical material in the filter may be recovered and elution buffer may be added to it before centrifugation.

After the centrifugation, a concentrated solution of the target such as the biological or chemical material may be obtained in the collection tube that is then ready for analysis, such as by using PCR, sequencing, metabarcoding, mass spectrometry or other analytical techniques.

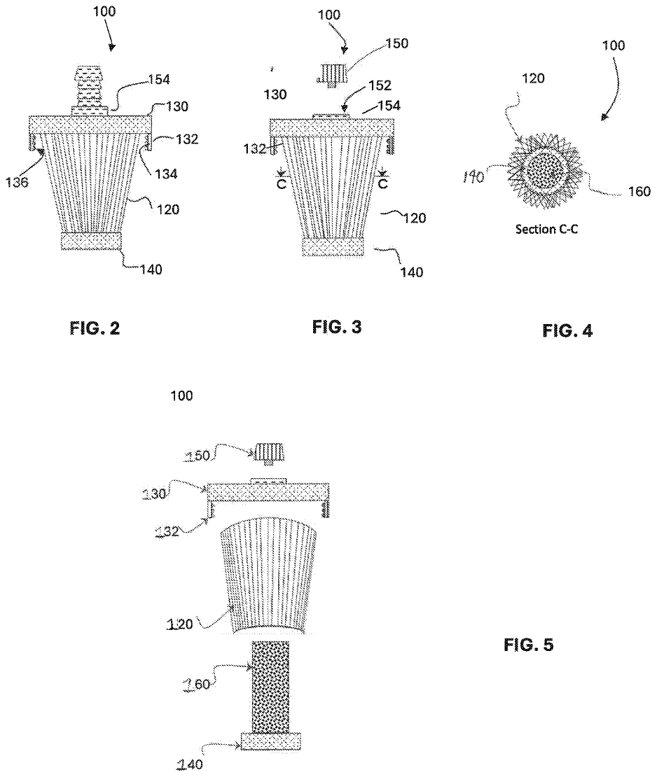

An example of a filtration cartridge 100 that may be used to filter air or a water sample according to various embodiments is shown in FIGS. 2-5. The filtration cartridge includes a filter 120 including one or more layers of filter material. In embodiments of filter cartridges for use in collection of air samples, the filter material may be a HEPA filter material. As shown, the filter 120 may be conical, though it could alternatively be cylindrical or have a different shape. The filtration cartridge 100 may include one or more fitting structures 154 for centrifugation or a pumping system, for example. In some embodiments, a filter cartridge for use in collecting air samples may include an adapter to fit into a hand-held vacuum that may pull in air to the cartridge to collect the sample. In contrast, a filtration cartridge for water sampling may include two fittings, one on the top of the cartridge and one at the bottom to allow passage of water through the device. The filtration cartridge 100 may include a top support 130 and a bottom support 140 that may be rigid, disc shaped structures that connect to and stabilize the filter 120. In some embodiments, the top and bottom supports 130, 140 may be plastic. In other embodiments, the top and/or bottom support may be somewhat flexible and made of a material other than plastic. In the embodiment shown, the top support 130 has a wider diameter than the bottom support 140. The top support 130 (located downstream when used in device 10 or other devices, for example) includes a downward projecting flange 132 extending circumferentially around an outer perimeter of the of the top support 130. The flange 132 includes an inner surface 134 which is spaced apart from the outer surface of the filter 120 by a small gap. Although the flange 132 extends fully around the top support 130, this gap can be seen in FIGS. 2 and 3 because the top and bottom supports 130, 140 are shown in cross section. The inner surface 134 includes projections 136 projecting inward which aid in connecting the flange 132 to the connector 62 in the housing 60 and to extraction devices such as a 50 mL centrifuge tube, as described later. The rib like projections may be comprised of any suitable material, such as rubber and/or plastic. In other embodiments, the rib like projections may be designed to form a screw fit for example with one or more apparatus, such as a centrifuge tube.

In some embodiments, the top support 130 may be solid and impermeable, except for a central aperture 152 (shown in FIG. 3). The central aperture may be surrounded by a flexible fitting 154 to enable a snug connection to other elements or devices. A central cylinder 160 may extend longitudinally through the center of the filtration device, from the top support 130 to the bottom support 140. The central cylinder 160 (shown in FIG. 4) may be in some embodiments a plastic non-porous, non-hollow cylinder that may be used to reduce free space inside of the filter cartridge, which may reduce the volume of reagents needed. Accordingly, the central cylinder may be used to reduce the volume of solutions or buffers needed for lysis and extraction of filtered targets such as biological and chemical targets.

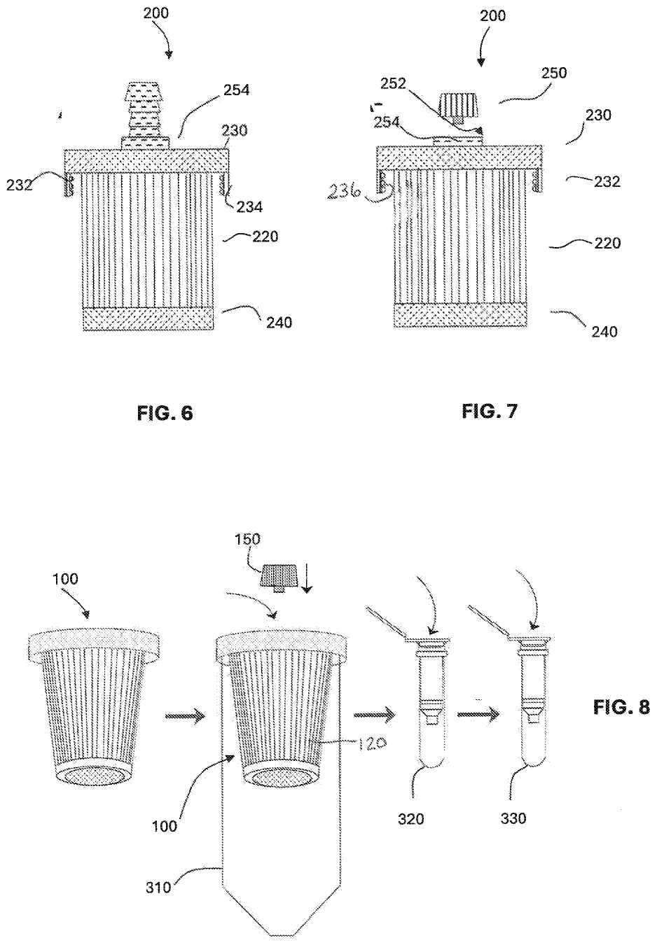

An alternative embodiment of a filter cartridge is shown in FIGS. 6 and 7. In this embodiment, the filter cartridge 200 may include a filter 220 that may be made of multiple layers of corrugated material. However, in this embodiment the filter may be shaped as a straight cylinder as opposed to being tapered. In other aspects, it is the same as the filter cartridge 100 of FIGS. 2-5 and may include fitting structures for centrifugation or a pumping system. The filtration cartridge 200 may include a top support 230 and a bottom support 240 that in some embodiments may be rigid, disc shaped structures that may be plastic and connect to and stabilize the filter 220. In other embodiments, the top and/or bottom supports may be semi-rigid, or flexible and/or made from a non-plastic material, or combination of materials. In the embodiment shown, the top support 230 has a wider diameter than the bottom support 232 at the downstream end. The top support 230 may include a downward projecting flange 232 extending circumferentially around an outer perimeter of the of the top support 230 with an inner surface 234 that is spaced apart from the outer surface of the filter 220 by a small gap.

The inner surface 234 in some embodiments may include projections 236 projecting inward that may aid in connecting the flange 232 to a connector in the housing and to extraction devices such as a 50 mL centrifuge tube.

The top support 230 may be solid and impermeable, except for a central aperture 252 surrounded by a flexible fitting 254 to enable a snug connection to other elements or devices. A central cylinder, not shown, in some embodiments may extend longitudinally through the center of the filtration device 200, from the top support 230 to the bottom support 240, similar to what is shown in the exploded view presented in FIG. 5. The central cylinder (not shown) may be in some embodiments a plastic, non-porous, non-hollow cylinder that may be used to reduce free space in the filter cartridge, which may reduce the volume of reagents needed. In other embodiments, the central cylinder may be semi-porous, or porous and/or may be hollow and/or semi-hollow.

FIG. 8 shows an example of a process they may be used for extracting and concentrating the target material isolated by a filtration cartridge like filtration cartridge 100 that is shown in FIGS. 1-5 . The filtration cartridge 200 of FIGS. 6-7 or other embodiments could alternatively be used. Other methods of extraction and concentration could alternatively be used, including centrifugation steps and/or other processes.

As shown in FIG. 8, after the filtration cartridge 100 is used for high volume air or gas sampling or water sampling using an appropriate system, like the device 10 or other device, the entire filtration cartridge 100 may be disconnected and removed from the device 10 or other device. The cartridge 100 may then be fitted onto and into a first receptacle such as a centrifuge tube 310 like a standard 50 mL centrifuge tube, for example. An appropriate solution for extracting the target from the filter 120 may then be added to the centrifuge tube 310. For example, a lysis buffer may be added to the receptacle such as the centrifuge tube. The filtration cartridge 100 may then be capped such as by inserting cap 150 into the filtration cartridge 100 and left to sit in the solution for an appropriate amount of time. For example, in some embodiments, the centrifuge tube may be filled with a lysis buffer and incubated for 5-10 min to neutralize and lyse cells and tissues and release the nucleic acids. Once sufficient time has passed to release the target, the receptacle such as the centrifuge tube may be centrifuged to recover the target such as the biological or chemical target at the bottom of the receptacle.

Next, the solution in the centrifuge tube 310 may be poured into a second receptacle such as a spin column 320. An appropriate solution such as a washing buffer may also be added to the second receptacle 320. The spin column 320 may then be capped and centrifuged. The spin column may then be recovered and introduced into a third receptacle such as a collection tube 330 to which an appropriate solution such as an elution buffer may be added, followed by centrifugation. The process results in a concentrate of the target material, such as the biological or chemical material. The concentrated target material may then be used for further analysis and identification. For example, the target material may be analyzed using PCR or sequencing or other analytical methods.

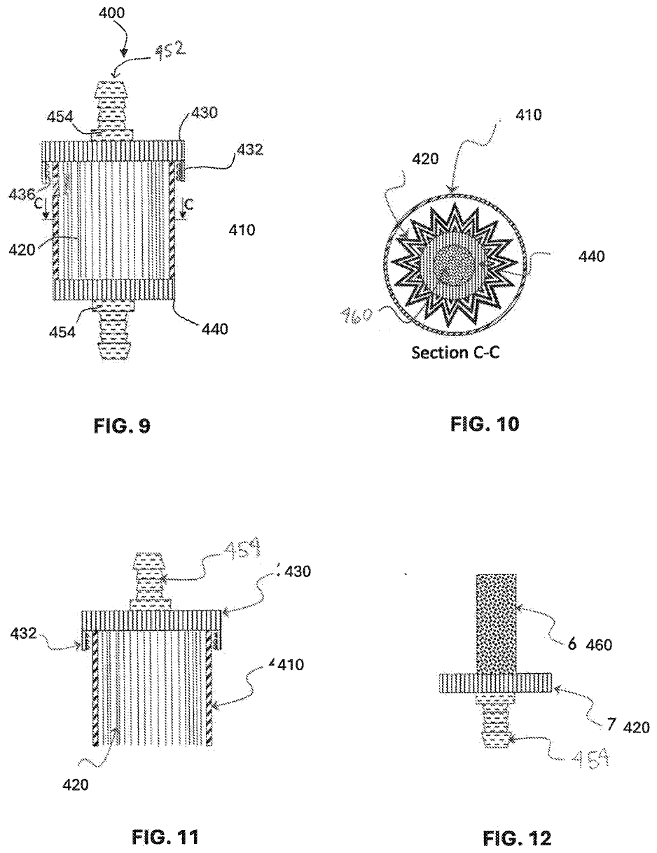

An alternative embodiment of a filtration cartridge is shown in FIGS. 9-12, which depicts a water filtration cartridge 400. The water filtration cartridge includes a filter 420 that may be cylindrical, but it could alternatively be conical or have a different shape. The filtration cartridge 400 may include a top support 430 and a bottom support 440 which may in some embodiments be rigid, disc shaped structures that connect to and stabilize the filter 420. In other embodiments, the top and/or bottom support may be semi-rigid, and/or flexible. In some embodiments, the top and bottom supports 430, 440 may be plastic. In other embodiments, the top and bottom supports may be partially plastic and/or comprised of any other suitable material. In the embodiment shown, the top support 430 has a wider diameter than the bottom support 440. The top support 430 (located downstream when used in a collection device) may include a downward projecting flange 432 extending circumferentially around an outer perimeter of the of the top support 430. The flange 432 includes an inner surface 434 which may be spaced apart from the outer surface of the filter 420 by a small gap. Although the flange 432 extends fully around the top support 430, this gap can be seen in FIGS. 9 and 11 because the top and bottom supports 430, 440 are shown in cross section. The inner surface of flange 432 may include projections 436 projecting inward which aid in connecting the flange 432 to the connector 62 in the housing 60 and to extraction devices such as a 50 mL centrifuge tube, as described later.

The top support 430 may be solid and impermeable in some embodiments, except for a central aperture 452. The central aperture may be surrounded by a flexible fitting 454 to enable a snug connection to other elements or devices. Likewise, the bottom support 440 may be solid and impermeable in some embodiments, except for a central aperture 452 surrounded by a flexible fitting 454. The flexible fittings 454 enable a snug connection to other elements or devices. For example, the filtration cartridge may be connected to a pump system for water filtration, or centrifuge.

FIG. 10 shows a top cross-sectional view of the filtration cartridge 400 at section C-C. The filtration cartridge includes a housing 410 surrounding the filter 420 including multiple layers of filter material in some embodiments. A central cylinder 460 may be located inside the filter 420. The bottom support 440 can also be seen.

FIG. 12 shows a side view of the central cylinder 460, separated from the filtration cartridge 400. The central cylinder extends longitudinally along the central axis of the filtration cartridge, from the bottom support 440 to the top support. The central cylinder may be non-hollow in order to reduce the volume of solutions or buffers needed for lysis and extraction of filtered targets such as biological and chemical targets. In other embodiments, the central cylinder may be hollow or semi-hollow.

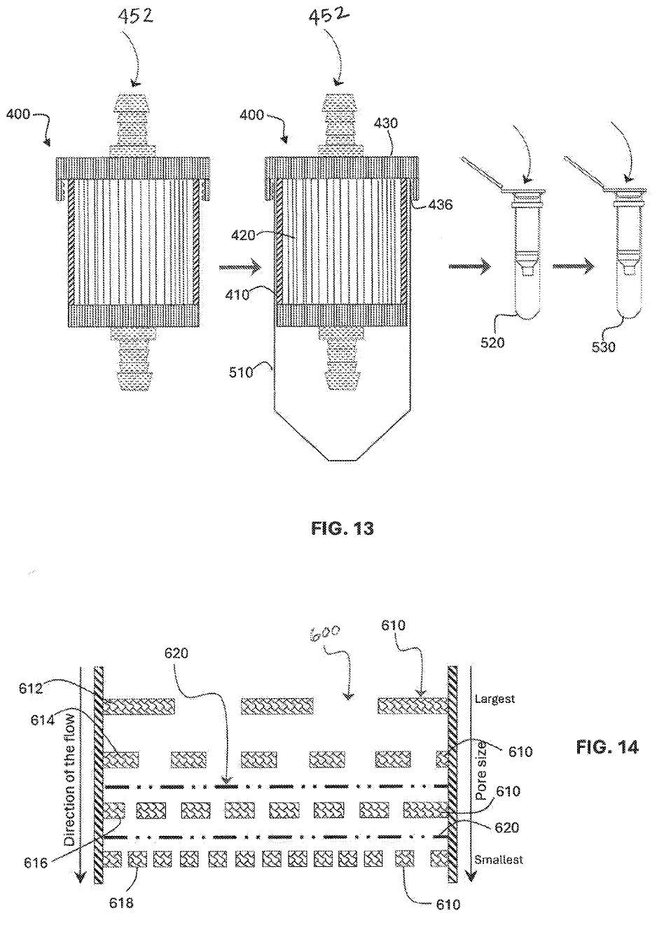

FIG. 13 presents a process for extraction and concentration of a target captured by a filtration cartridge such as filtration cartridge 400, though this process could alternatively be used with other embodiments of the filtration cartridge.

The process begins with use of the filtration cartridge 400 (or other filtration cartridge) to capture a target such as a biological or chemical cartridge from a large volume of fluid such as water, using a filtration system or device. The entire filtration cartridge 400 may then be removed from the filtration system and be ready to use in the process shown in FIG. 13 without any modification of the filtration cartridge, and without modifying or touching or removing the filter 420 from the cartridge. Filtration cartridge 400 may quickly and easily be connected to the extraction receptacle 510.

After removal of the filtration cartridge 400 from the system, it may be inserted into and connected to a first receptacle such as a centrifuge tube 510, such as a 50 mL centrifuge tube. An appropriate solution may be added to the centrifuge tube, such as a lysis buffer, by pouring the solution through the top aperture 452 and into the central cylinder within the filter 420. In embodiments in which a 50 mL centrifuge tube is used, about 10 to about 20 mL of lysis buffer may be added to the centrifuge tube. The filter may be left to sit in the solution for an appropriate amount of time, such as for a few minutes of incubation. The centrifuge tube 510 with the attached filtration cartridge 400 and the filter 420 within it may then be placed inside a centrifuge and then centrifuged to extract the target, such as the biological or chemical materials, in the solution that falls into the bottom of the centrifuge tube 510.

The solution may then be poured out of the centrifuge tube 510 and into a second receptacle, such as a spin column 520. An appropriate solution such as a washing buffer may be added to spin column 520. The spin column 520 may then be centrifuged. The spin column containing the target material such as the biological or chemical material may then be placed into a collection tube 530 and an appropriate solution such as an elution buffer may be added, followed by centrifugation to recover a concentrated target such as the biological or chemical material at the bottom of the collection tube 530. The concentrated target may then be analyzed for identification, such as by PCR identification or sequencing or other analytical method.

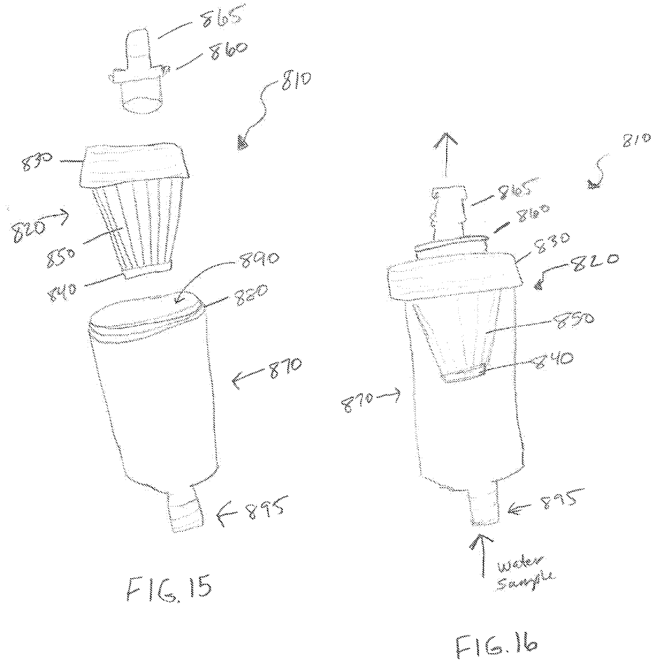

FIG. 14 is a representative schematic cross-sectional side view of a filter according to various embodiments, with the direction of flow indicated by the large arrows. In one embodiment, the filter 600 may include multiple filter material layers 610 with various pore sizes inside of a filter cartridge. In the embodiment shown, there are four filter material layers 610, with varying pore sizes which decrease progressively from the top filter material layer 612 having the largest pores to the bottom filter material layer 618 having the smallest pores. The other filter material layers 614 616 may have pore sizes in between those of the top and bottom filter material layers 612, 618. In other embodiments, there may be more or less layers of filter material, and/or the different layers may have any pore size. The filter may also include two layers of spacer material 620, which may be optionally included in any of the embodiments. The spacer material 620 may be a nonporous material such as plastic or metal or other material which may include channels to permit flow of the material or may be a mesh material, for example. In the embodiment shown in FIG. 14, there are only two spacer layers 620, located directly upstream and downstream of middle filter material layer 616. In other embodiments, there may be more layers, such as a spacer layer between each filter material layer, or there may be fewer spacer layers.

Although other filter configurations may be used, placing the filter material layers in a stacked configuration as shown in FIG. 14, such that the water, air or other material flows through the filter from the largest pore size to the smallest, helps reduce filter clogging and increase sample volume capacity by capturing large biological materials (e.g. tissue) first then smaller material such as cells, microorganisms, then even smaller material such as viruses and free DNA. In this way, by reducing clogging, the filter may be able to capture more of the target material such as biomass.

In the foregoing description, embodiments of the present disclosure have been described with reference to specific embodiments. However, it may be understood that various modifications and changes may be made without departing from the scope of the inventions.

What is claimed is:

1. A filter cartridge for collecting samples for testing, the filter cartridge comprising:
a filter having a top end and a bottom end, the filter further comprising multiple layers of corrugated filter material, wherein a hollow core runs through the center of the filter from the top end of the filter to the bottom end of the filter;
a housing comprising:
a top support connected to the top end of the filter, the top support covering the entire top end of the filter, the top support further comprising a flange extending toward the bottom end of the filter, wherein the flange is spaced apart from the filter to create a gap;
the top support further comprising an opening to access the filter, wherein the opening in the top support is surrounded by a fitting;
a bottom support having a circumference smaller than a circumference of the top support, the bottom support further comprising a center cylinder centrally placed on and connected to a top surface of the bottom support, wherein a circumference of the center cylinder is smaller than the circumference of the bottom support and wherein the bottom support is connected to the filter such that the center cylinder of the bottom support resides in the hollow core of the filter and the bottom end of the filter connects to the top surface of the bottom support.

2. The filter cartridge of claim 1, wherein the sample collected is an airborne sample.

3. The filter cartridge of claim 2, further comprising an adapter that connects the cartridge filter to a handheld vacuum for collecting a sample from the air.

4. The filter cartridge of claim 3, wherein the filter material comprises a HEPA material.

5. The filter cartridge of claim 1, wherein the center cylinder is non-hollow.

6. The filter cartridge of claim 5, further comprising a removably securable cap that secures to the fitting on the top support.

7. The filter cartridge of claim 1, further comprising an interior side of the flange closest to the filter comprises a plurality of projections.

8. The filter cartridge of claim 7, wherein the top support removably secures to a centrifuge tube.

9. The filter cartridge of claim 8, wherein the top support removably secures to a spin tube.

10. A filter cartridge for collecting samples from water, the filter cartridge comprising:
a filter with a top end and a bottom end, the filter having a hollow core running from the top end of the filter to the bottom end of the filter;
a housing body that the entire filter fits into, the housing body having a top support fit over a top end of the housing body, and a bottom support fit over a bottom end of the housing body, wherein the top end of the filter is connected to the top support;
the top support having an opening to access the filter placed in the housing, wherein the opening in the top support is surrounded by a fitting;
a bottom support having an opening to access the filter placed in the housing, wherein the opening in the bottom support is surrounded by a fitting; and
a central cylinder that runs from the top support to the bottom support and through the hollow core of the filter.

11. The filter cartridge of claim 8, further comprising a first removably securable cap that secures to the fitting of the top support.

12. The filter cartridge of claim 9, further comprising a second removably securable cap that secures to the fitting of the bottom support.

13. The filter cartridge of claim 10, wherein the top support removably secures to a centrifuge tube.

14. The filter cartridge of claim 13, wherein the top support removably secures to a spin tube.

15. The filter cartridge of claim 13, wherein the filter is comprised of a plurality of filter material layers, each filter material layer having a pore size.

16. The filter cartridge of claim 15, wherein at least two of the plurality of filter material layers have different pore sizes.

17. The filter cartridge of claim 10, wherein the central cylinder is non-hollow.

18. A method of processing environmental samples, the method comprising the steps of:
placing a filter cartridge for collecting the environmental sample in a location of interest, wherein the filter cartridge comprises a filter disposed between a top support and a bottom support, wherein the top support has an opening to access the filter disposed therein, and wherein the opening is surrounded by a fitting;
placing the filter cartridge, after the environmental sample has been collected, into a centrifuge tube, wherein the top support of the filter cartridge secures to a top of the centrifuge tube;
pouring a centrifuging fluid through the opening of the top support;
performing centrifuge on the centrifuge tube containing the filter cartridge containing the environmental sample;
collecting a target result of the centrifuge process from the bottom of the centrifuge tube;
placing the target result collected from the centrifuge tube into a spin tube with a washing buffer solution and centrifuging the spin tube;
collecting a target from the spin tube after the spin tube has been centrifuged and placing the target from the spin tube in a collection tube with a buffer solution and centrifuging the collection tube;
collecting a concentrated target after centrifuge in the collection tube and performing analysis on the concentrated target.

19. The method of claim 18, wherein the location of interest is a surface.

20. The method of claim 18, wherein the location of interest is in water.
